(19) United States
(12) Patent Application Publication
(10) Pub. No.: US 2009/0299563 A1
(43) Pub. Date: Dec. 3, 2009

(54) METHOD OF MASS TRANSFORTATION OF PEOPLE OR CARGO, ESPECIALLY WITHIN CITY AREAS AND A TRANSPORT INFRASTRUCTURE FOR THE IMPLEMENTATION OF THIS METHOD

(76) Inventor: Olgierd Mikosza, Poronin (PL)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/910,048

(22) PCT Filed: Apr. 3, 2006
(86) PCT No.: PCT/PL06/00022

§ 371 Date: Sep. 28, 2007

(30) Foreign Application Priority Data
Apr. 4, 2005 (PL) P-374127

(51) Int. Cl. B60F 1/00; G01S 1/00; G05D 1/00; E01B 25/00; B60K 8/00; B61B 1/00; B61B 5/00; B62D 49/08

(52) U.S. Cl. 701/25; 701/213; 104/124; 280/755

(57) ABSTRACT

The method of carrying persons or cargo in the individual vehicles (3) being moved between stations (1) via separate communication corridors (2) on individual trip orders, whilst a transported person, a small group of people or cargo are being carried individually in the adopted individual vehicles (3) along the ordered route, at least, from the starting station (4) directly or nearly directly to the destination station (6) via the communication corridors (2) and also, beneficially, to the starting station (4)and from the destination station (6) on the public roads (5) and, in addition, at least within the communication corridors (2), each of the individual vehicles (3) is driverless, controlled centrally and autonomously. The transport infrastructure is characterised in that is consists of communication structure including separate communication corridors (2) and the individual vehicles (3) designed for individual carrying of a small group of people or a small cargo loads along the route defined by an individual order, at least, from the starting station (4) directly or nearly directly to the destination station (6) via the communication corridors (2) and, beneficially, to the starting station (4) and from the destination station (6) on the public roads (5). At least within the communication corridors (2), each of the individual vehicles (3) is driverless, controlled centrally and autonomously. Communication structure has a form of an opened communication structure (13), where the communication corridor (2) consists of a contiguous main rail supported on the columns (27), whilst individual vehicles (3) are placed upon this mail rail (9) moveably in one direction only. Beneficially, the communication corridor (2) is in the form of an underpressurized communication corridor (13).

### STATEMENT OF RELATED APPLICATION

This application is the U.S. National Phase Under Chapter II of the Patent Cooperation Treaty (PCT) of PCT International Application No. PCT/PL2006/000022 having an International Filing Date of 3 Apr. 2006, which claims priority on Polish Patent Application No. P-374127 having a filing date of 4 Apr. 2005.

### BACKGROUND OF THE INVENTION

1. Technical Field

The subject of the invention is a method for mass transportation of people or cargo, especially within city areas, whereby persons or cargo are carried by the mechanical vehicles between stations along communication corridors and a transport infrastructure for such mass transportation of people or cargo, especially within city areas, mechanical vehicles for carrying of people or cargo and stations interconnected via communication corridors.

2. Related Art

There are commonly known solutions regarding methods for mass transportation of people or cargo, as well as solutions regarding transport infrastructure for mass transportation of people or cargo, whereby people or cargo are carried by the mechanical vehicles like rail carriages, being moved between the stations via separate and protected communication corridors like railway tracks or via underground tunnels like a metro. By means of those known solutions people or cargo are usually transported on predetermined routes and at predetermined times, generally defined by fixed timetables, using mechanical vehicles like trains adopted for carrying large numbers of people or goods, while trains are generally controlled manually by drivers, without possibility to autonomously choose a route or to change the time of travel, and, in addition, the people or cargo are being generally carried only between the stations.

There are also commonly known solutions regarding methods for transporting people or cargo, the solutions dealing with the transport infrastructure used for carrying of people or cargo, especially within city areas, whereby people or cargo are carried by the mechanical vehicles like passenger taxis or goods trucks being controlled manually by drivers and used essentially on the public roads, which are often congested.

### BRIEF SUMMARY OF THE INVENTION

The purpose of the invention is to provide solutions to the prior art problems, allowing for a fast and collision less transporting of people or cargo, especially within city areas, for reducing of the vehicles congestion, traffic jams and accidents on public roads and, in addition, for reducing energy consumption needed for powering of mechanical vehicles and for decreasing of environment pollution.

A method for mass transportation of persons or cargo, especially in city areas, whereby persons or cargo are being carried in the mechanical vehicles, which are moved between stations in separate communication corridors, while transporting of persons or cargo is performed in the individual vehicles along the ordered route, according to the invention, while individual vehicle being moved to the indicated in the trip order starting point from one of the neighboring station or from the destination point of a previous trip, if it was nearby, then from this starting point to the nearest starting station along the public roads, next from this starting station to the destination station located nearest to the indicated in the trip order destination point along the communication corridors and subsequently, from that destination station to the destination point and back to the nearest station or to the next trip's starting point, if it is nearby, again on the public roads, whilst, at least in the communication corridors, each individual vehicle is driverless, controlled autonomously with the help of the centrally gathered information about the status of the entire system. The individual vehicles are moved in the communication corridors by propulsion units being part of the individual vehicles, installed in these communication corridors, whilst the individual vehicles enter into communication corridor and exit it, as well as transfer between these communication corridors, in a collision less manner, beneficially, at the intersections of these communication corridors or in the station areas.

It is beneficial if the individual vehicles are traveling on the public roads at low speeds, allowed in the city traffic on those public roads, while, beneficially, in the communication corridors, the individual vehicles are moving at much higher speeds than those allowed on the public roads.

Further benefits are derived if the individual vehicles are moved along the optimal routes because of the minimal expected travel time or minimal energy usage, whilst gathering data in the central database both in real time and historically, at least in relation to the loading of the communication corridors, about waiting times for entering into such communication corridors from particular stations, location of individual vehicles, their occupancy and release rates and loading of particular public roads, whilst individual vehicles are controlled autonomously with the use of computers and, beneficially, with the use GPS satellite navigation.

Beneficially the selection of the individual vehicles for the fulfillment of the of individual trip orders, is controlled centrally or locally from the nearest station, whilst the trip travel route is chosen autonomously by the individual vehicle taking into account centrally gathered data as well as calculations performed in real time by the individual vehicle, in regard to the expected travel time or energy consumption, depending on the different routes and actual passengers' orders related to the destination point or changes to those orders during the trip.

Subsequent benefits are derived if the individual vehicles, when there is no demand for them at a given time, are stored in the stations areas and if the individual vehicles, which are traveling on the public roads, awaiting for subsequent trip orders, are gathered in marked parking places or near the end point of their last trip.

A transport infrastructure for carrying of persons or cargo, especially in city areas, consisting of individual mechanical vehicles for transporting persons or cargo and stations connected by separate communication corridors, wherein communication structure has a form of, is characterizing of the opened communication structure, and where communication corridor contains at least one contiguous main rail, supported on the columns, whilst upon the main rail there are propulsion-carrier units placed moveably in one direction only, and to which propulsion-carrier units are attached individual vehicles.

It is beneficial if the propulsion-carrier units of the communication corridors are movably placed on the crossover rails of the communication structures, which are positioned in parallel and in a non contact manner alongside the main rails of the communication corridors, beneficially, near stations, whilst the crossover rails of the transport infrastructure are connecting in a collision less manner the adjacent or intersecting sections of the main rails of the communication corridors. The individual vehicle traveling in the communication corridor is stabilized horizontally by leveling wheels.

Further benefits are derived if the individual vehicle is of modular design and consists of, at least, a carrier module, as well as transport module arranged in the form of a passenger cabin or a cargo container whilst the transport module of the individual vehicle is attached to the universal carrier module, which is prepared for travel on the public roads and in the communication corridors and is equipped with at least one propulsion module.

As can be seen from the above, solutions according to the invention allow for fast and collision less transportation of people or cargo in the city areas, reduction of traffic jams, congestion and collisions on the public roads and, in addition, allow for a reduction in the energy consumption for propulsion of mechanical vehicles by reduction of the mass of the individual vehicles and reduction of environment pollution. In the communication corridors, individual vehicles can be moved at high speeds with minimal energy consumption, while when traveling on public roads, individual vehicles are moved at low speeds, safe for city traffic speeds, e.g. up to 40 km/h. Within the communication structure, individual vehicles can travel close to each other being supplied by an external power source provided inside the communication structure, completely automatically and driverless. However, outside of the communication structure, individual vehicles can also travel completely automatically and driverless thanks to the computer control and GPS satellite navigation, or in a simpler version, can be driven by one of the passengers, like electric cars.

### BRIEF DESCRIPTION OF THE DRAWING FIGURES

The subject of the invention is presented in examples of implementation in the drawing, wherein:

FIG. 1 shows a network of stations connected by communication corridors of the transport infrastructure, in a schematic view.

FIG. 2 shows a fragment of the transport infrastructure in the merging area, where an individual vehicle changes from the crossover rail onto the main rail of the communication corridor, in a schematic view.

FIG. 3 shows a fragment of the transport infrastructure in an exit area, where individual vehicle changes from the main rail of the communication corridor onto the crossover rail, in a schematic view.

FIG. 4 shows a fragment of the transport infrastructure with main and crossover rails in the station area, in a schematic view.

FIG. 5 and FIG. 6 show a fragment of the transport infrastructure with main and crossover rails in areas of the intersection of the communication corridors, in a schematic view.

FIG. 7 shows a carrier-propulsion unit of the communication structure, in a cross-section.

FIG. 8 shows an individual vehicle coupled to a carrier-propulsion unit of the communication structure, in a longitudinal section.

FIG. 9 shows the same individual vehicle, in a side view.

FIG. 10 shows a fragment of the opened communication structure, with four opened communication corridors, in a perspective view.

FIG. 11 shows a fragment of the communication structure with horizontal stabilization wheels of the individual vehicle, in a cross-section.

### DETAILED DESCRIPTION OF PREFERRED EMBODIMENTS

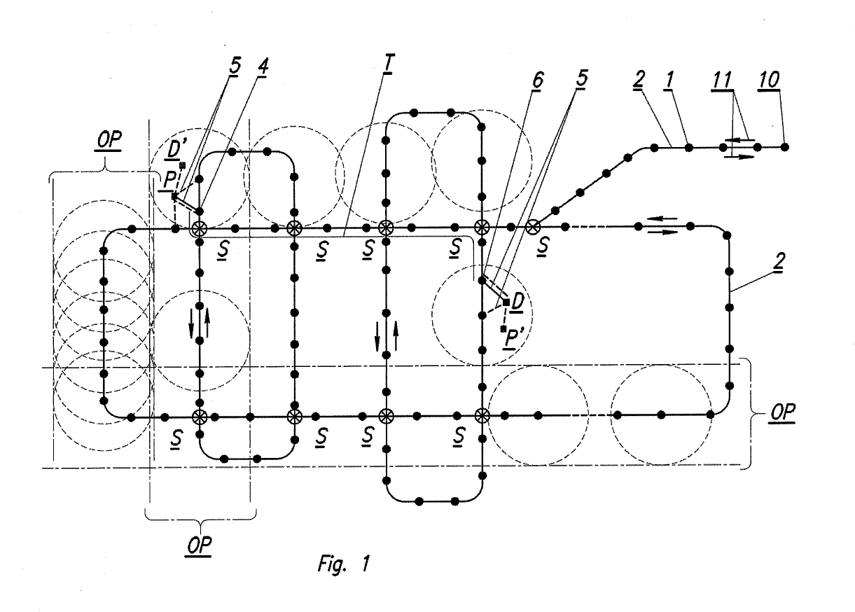

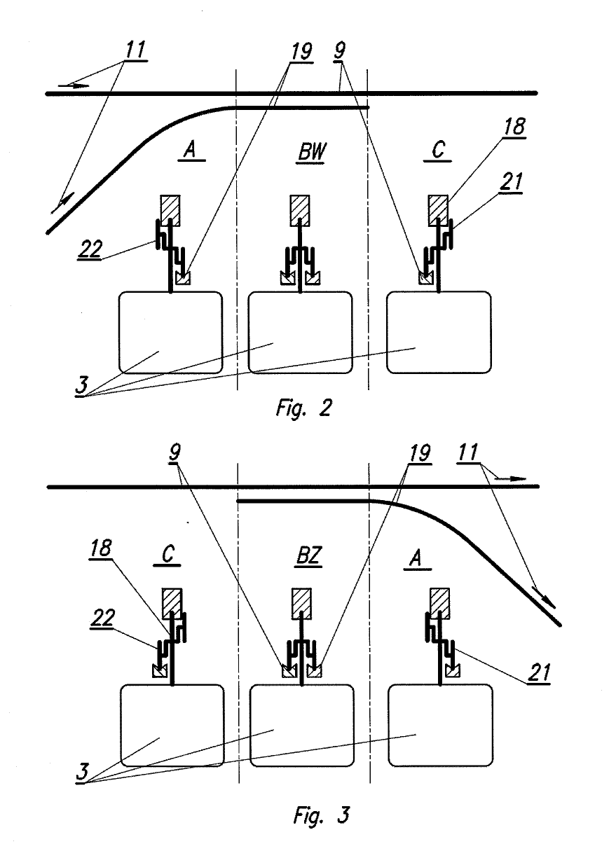

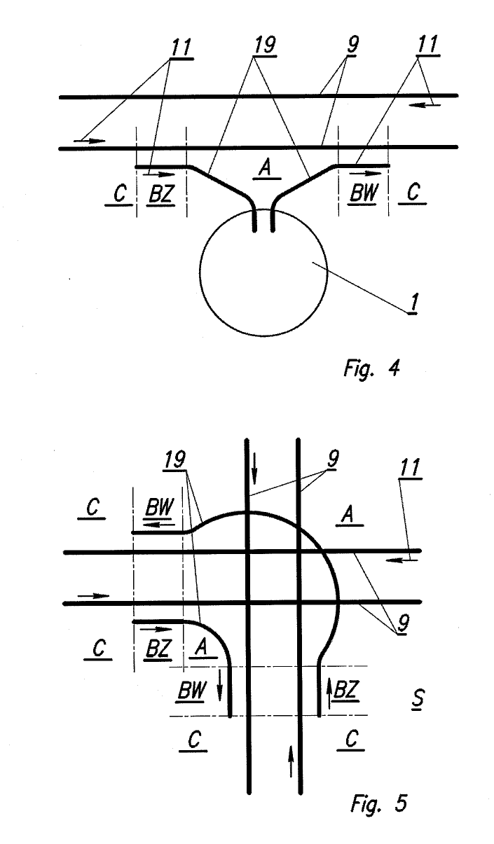

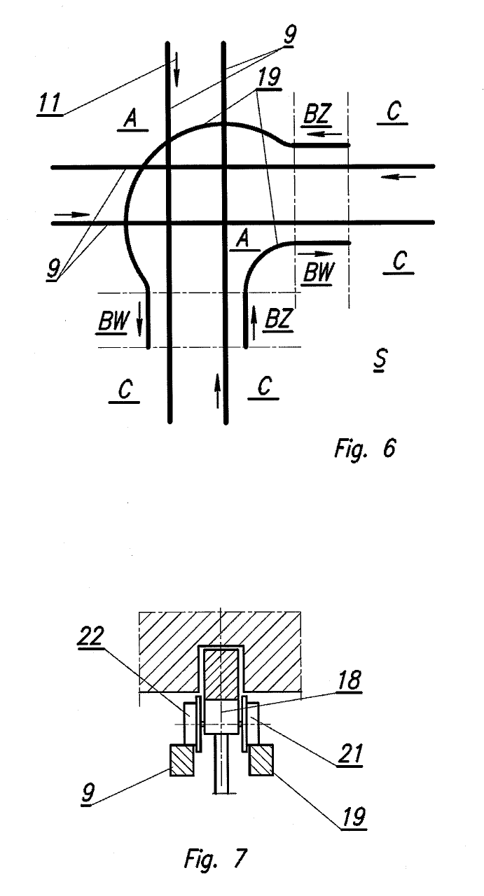

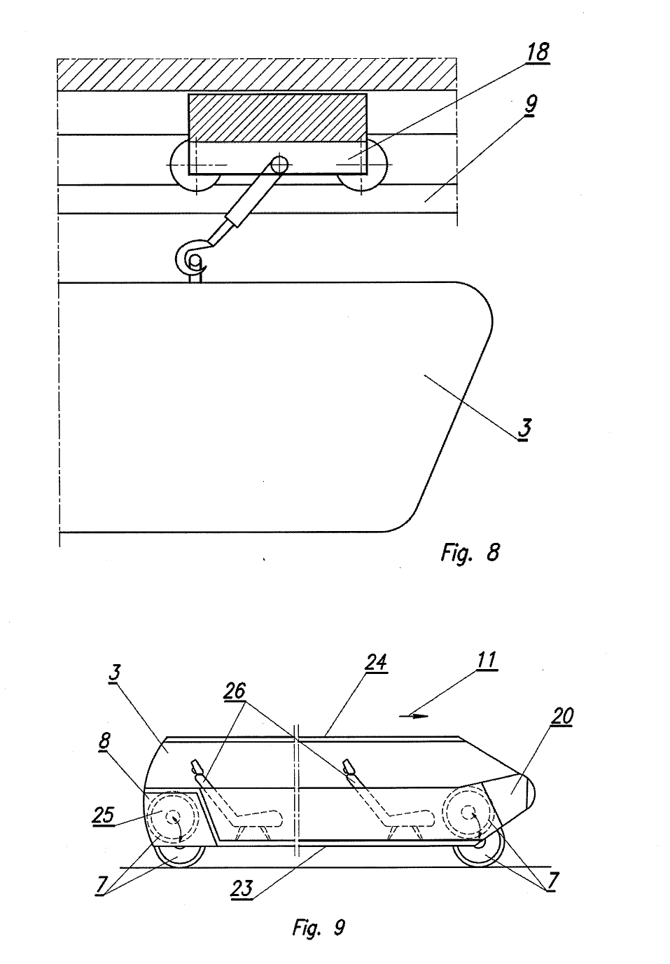

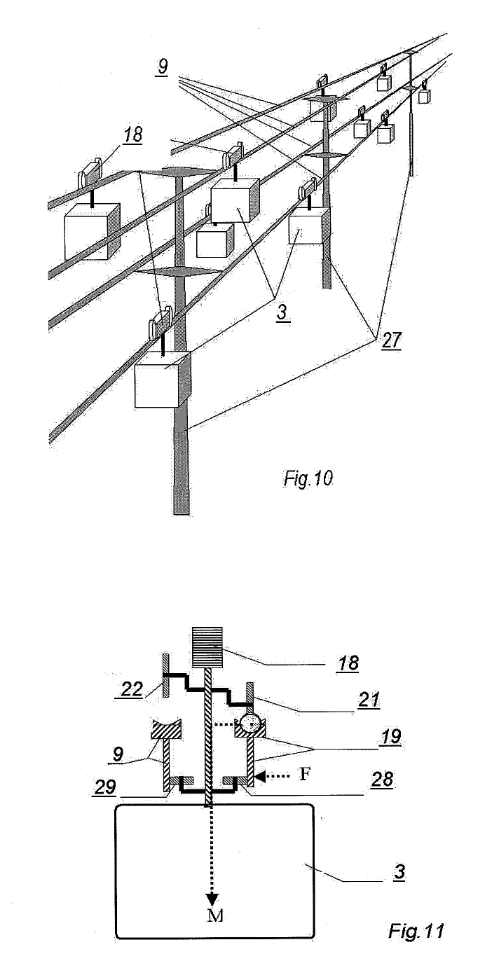

In the preferred example of the method according to the invention, people or cargo are carried in the mechanical vehicles moving between stations 1 in the separate communication corridors 2. People or cargo are transported on individual trip orders. Transported person, small group of people or cargo are moved individually in adapted mechanical vehicles being individual vehicles 3, along the ordered route, as per the example of trip T on FIG. 1, from the starting station 4 directly or almost directly i.e. without intermediate stops or with a minimal number of intermediate stops to the destination station 6 via the communication corridors 2, where each of the individual vehicles 3 is driverless, controlled autonomously and centrally. The individual vehicle 3, moves to the designated starting point P of the ordered trip from one of the neighboring stations 1 or from the destination point D′ of a previous trip, if nearby, on the public roads 5, then it moves from this starting point P to the nearest starting station 4 on the public roads 5 and then from the starting station 4 to the destination station 6 located nearest to the destination point D via the communication corridors 2 and, subsequently, again on the public roads 5, it moves from the destination station 6 to the destination point D and back to the station 1 nearest to point D or to the starting point P′ of the next trip, if nearby. In the communication corridors 2 the individual vehicles 3 are moved one way and in a collision less manner. On the public roads 5 the individual vehicles 3 are moved at small speeds allowed in city traffic on these public roads 5.

In the next example of the method according to the invention, individual vehicles 3 are moved within the communication corridors 2 whilst coupled to electrical propulsion units, which are in turn moved upon the main rail 9, while propulsion units are entered into the communication corridor 2 and leaving it, in a collision less manner in the station area 1 and, additionally, propulsion units are transferred in a collision less manner between the communication corridors 2, at their intersections S and in the terminal station areas 10. Stations 1 are spaced along the communication corridors 2, no further from each other than the operating range of the individual vehicle 3 during its travel on the public roads 5 or in the walking range of pedestrians, who might be using metro or buses, with the variant of the individual vehicle 3 traveling only in the communication corridors 2 between the stations 1. This results in the creation of the coverage strips OP having a width of approximately two such relevant ranges, and such coverage strips OP are used to cover service areas for transporting of people or cargo.

The communication corridors 2 are usually placed in pairs so that the individual vehicles 3 can travel in opposite directions marked by arrows 11, creating one communication channel.

The individual vehicles 3 are moved along the optimal routes because of the minimal expected travel time or minimal energy usage, while gathering data in the central database both in real time and historically, at least in relation to the loading of communication corridors 2 and waiting times for entering into such communication corridors 2 from particular stations 1 location of individual vehicles 3, their occupancy and release rates, as well as congestion on particular public roads 5. The travel route is being selected autonomously by each individual vehicle 3 taking into account centrally gathered data as well as calculations performed in real time by the individual vehicle 3, as to the expected travel time or energy consumption depending on the different possible routes and actual passengers' requests related to the destination point D or changes to those requests during the trip. Selection of the individual vehicles 3 for the fulfillment of individual trip orders is controlled centrally or from the nearest station 1. The individual vehicles 3 are driverless and are operating autonomously, using computer control and GPS satellite navigation.

In the next example of the method according to the invention, during the movement of the individual vehicles 3 in the communication corridors 2, electrical energy is being accumulated in the individual vehicles 3, which is then necessary for their movement outside of the communication corridors 2, when the individual vehicles 3 are powered from the electric source provided inside of the communication corridors 2 for the purpose of recharging of their electric accumulators.

In the preferred example of the implementation of the transport infrastructure according to the invention the communication corridor 2 has a form of an opened transport structure, equipped with one or more main rails 9 supported on the columns 27 of the transport infrastructure, where upon such main rails 9 of communication corridors 2, there are placed vehicles 3 being moved one way in relation to each one of main rails, and where each driverless individual vehicles 3 is controlled centrally and autonomously.

The propulsion-carrier units 18 of the communication corridors 2 are movably placed on the crossover rails 19 of the communication structures, which are positioned in parallel and in a non contact manner alongside the main rails 9 of the communication corridors 2, beneficially, near stations 1, whilst the crossover rails 19 of the transport infrastructure 27 are connecting in a collision less manner the adjacent or intersecting sections of the main rails 9 of the communication corridors 2.

The communication corridor 2 is equipped with propulsion units, in the form of electrically powered, individual propulsion- carrier units 18, to which individual vehicles 3 are attached and which are then moved together and collision less between adjacent or crossing sections of communication corridors 2, and also in the stations areas 1, i.e. in each of the entry areas BW and exit areas BZ. Individual vehicles 3 are attached to electrical propulsion-carrier units 18, which are moveably placed upon a common main rail 9. Propulsion-carrier units 18, are also moveably placed upon a crossover rails 19, which are positioned in communication corridors 2 in parallel and in a non contact manner next to the main rail 9, at intersections S of these communication corridors 2 and near the stations 1, for the purpose of entering or exiting of the individual vehicle 3 into/out of the communication corridors 2 in both variants of the communication structure.

In each of the entry areas BW for the individual vehicle 3 into the communication corridor 2, propulsion-carrier unit 18, together with the individual vehicle 3 is changing from a crossover rail 19 onto the main rail 9, so that in the external area A, which is before entry area BW, propulsion-carrier unit 18 is placed upon a crossover rail 19 only on its right hand side wheels 21. In the entry area BW it is suspended upon crossover rail 19 on its right hand side wheels 21 and simultaneously upon main rail 9 on its left hand side wheels 22. Finally, in the internal area C, which is after entry area BW into the communication corridor 2, it is suspended upon main rail 9 only on its left hand side wheels 22.

And in turn, in each of the exit areas BZ for the individual vehicle 3 from the communication corridor 2, propulsion-carrier unit 18, together with the individual vehicle 3 is changing from main rail 9 onto the crossover rail 19. In the internal area C located in the communication corridor 2, which is before exit area BZ, propulsion-carrier unit 18 is only suspended upon main rail 9 on its left hand side wheels 22. Next, in the exit area BZ of the communication corridor 2, it is suspended upon main rail 9 on its left hand side wheels 22 and simultaneously upon crossover rail 19 on its right hand side wheels 21. Finally, in the external area A, which is after exit area BZ and outside of the communication corridor 2, it is suspended upon crossover rail 19 only on its right hand side wheels 21.

Obviously, it is possible to place main rail 9 in relation to the crossover rail 19 for the left hand side traffic, where propulsion-carrier unit 18 is suspended upon main rail 9 on its right hand side wheels 21 and upon crossover rail 19 on its left hand side wheels 22.

Crossover rails 19 of the communication corridors 2, connect, in a collision less manner, adjacent and crossing sections of main rails 9 of the communication corridors 2.

In the subsequent example of the implementation of the transport infrastructure according to the invention, shown on FIG. 11 it provides for a perpendicular-horizontal stabilization of the individual vehicles 3 suspended like a cable gondola from a propulsion-carrier unit 18 placed upon a single main rail 9 or on a crossover rail 19, as a protection against change of the centre of gravity of the individual vehicle 3 or against wind action in the opened communication corridors 2, where the individual vehicle 3 being moved in the communication corridor 2 is stabilized horizontally by leveling wheels 28 and 29. During the travel on a crossover rail 19, a horizontal reaction force F of this crossover rail 19 against the right hand side leveling wheel 28 is countered by a momentum M caused by misalignment of the centre of gravity of the individual vehicle 3 in relation to the contact point on an a crossover rail 19. Similarly, during travel on the main rail 9, left hand side leveling wheel 29 counters a force momentum caused by misalignment of the centre of the gravity of vehicle 3 in relation to the contact point on main rail 9.

In another example of the implementation of the transport infrastructure, the individual vehicle 3 is of modular design and consists of, at least, a carrier module 23, as well as transport module 24 arranged in the form of a passenger cabin or a cargo container whilst the transport module 24 of the individual vehicle 3 is attached to the universal carrier module 23, which is prepared for travel on the public roads 5 and in the communication corridors 2 and is equipped with at least one propulsion module 25.

The individual vehicles 3 are moved on the public roads 5 on carrier wheels 7, which can be retracted into the individual vehicles 3 when these individual vehicles 3 are moved within the communication corridor 2, and whilst individual vehicles 3, during the movement on the roads 5, are propelled by the electric motor 8, and the energy necessary for movement of the individual vehicles 3 on the public roads 5 is accumulated at the stations 1 or during the movement of the individual vehicles 3 in the communication corridors 2.

1. A method for mass transportation of persons or cargo, especially in city areas, whereby persons or cargo are being carried in individual vehicles, which are moved between stations in separate communication corridors (2), while transporting of persons or cargo is performed in the individual vehicles along the ordered route, comprising the individual vehicles (3), being moved to a starting point (4P) as indicated in the trip order from one of neighboring station (1), or from a previous destination station (D′) of a previous trip, if the previous destination station was nearby, then from this starting point (P) to the nearest starting station (4) along the public roads (5), next from this starting station (4) to the next destination station (6) located nearest to the destination point (D) indicated in the trip order along the communication corridors (2), and subsequently, from that destination station (6) to the destination point (D) and back to the nearest station (1) or to the next trip's starting point (P′), if it is nearby, again on the public roads (5), whilst, at least in the communication corridors (2), each of the individual vehicles (3) is driverless, controlled autonomously with the help of centrally gathered information about the status of the entire system.

2-57. (canceled)

58. The method according to claim 1, further comprising moving of the individual vehicles (3) in the communication corridors (2) by propulsion units being part of the individual vehicles (3), installed in the communication corridors (2), whilst the individual vehicles (3) enter into the communication corridor (2) and exit it, as well as transfer between the communication corridors (2), in a collisionless manner, beneficially, at the intersections (S) of the communication corridors (2) or in the station areas (1).

59. The method according to claim 1, further comprising moving of the individual vehicles (3) on the public roads (5) at low speeds, allowed in the city traffic on those public roads (5), while, beneficially, in the communication corridors (2), the individual vehicles (3) are moving at much higher speeds than those allowed on the public roads (5).

60. The method according to claim 1, further comprising moving of the individual vehicles (3) along optimal routes (T) because of minimal expected travel time or minimal energy usage, whilst gathering data in a central database both in real time and historically, at least in relation to loading of the communication corridors (2), about waiting times for entering into the communication corridors (2) from particular ones of the stations (1), location of the individual vehicles (3), their occupancy and release rates and loading of particular ones of the public roads (5), whilst the individual vehicles (3) are controlled autonomously with the use of computers and, beneficially, with the use GPS satellite navigation.

61. The method according to claim 1, further comprising selecting of the individual vehicles (3) for the fulfillment of the of individual trip orders, being controlled centrally or locally from the nearest station (1), whilst the trip travel route (T) is chosen autonomously by the individual vehicle (3) taking into account centrally gathered data as well as calculations performed in real time by the individual vehicle (3), in regard to the expected travel time or energy consumption, depending on the different routes and actual passengers' orders related to the destination point (D) or changes to those orders during the trip.

62. The method according to claim 1, further comprising storing of the individual vehicles (3), when there is no demand for them at a given time, in the stations areas (1) and gathering of the individual vehicles (3), which are traveling on the public roads (5), awaiting for subsequent trip orders, in marked parking places or near the end point of their last trip.

63. A transport infrastructure for carrying of persons or cargo, especially in city areas, consisting of individual mechanical vehicles for transporting persons or cargo and stations connected by separate communication corridors, wherein communication structure comprises an opened communication structure (13′), and where a communication corridor (2) contains at least one contiguous main rail (9), supported on columns (27), whilst upon the main rail (9) there are propulsion-carrier units (18) placed moveably in one direction only, and to which the propulsion-carrier units (18) are attached to the individual vehicles (3).

64. The transport infrastructure according to claim 7, wherein the propulsion-carrier units (18) of the communication corridors (2), which are movably placed on crossover auxiliary rails (19) of the communication structures, which are positioned in parallel and in a non contact manner alongside the main rails (9) of the communication corridors (2), beneficially, near stations (1), whilst the crossover auxiliary rails (19) of the columns (27) are connecting in a collision less manner the adjacent or intersecting sections of the main rails (9) of the communication corridors (2).

65. The transport infrastructure according to claim 7, wherein the individual vehicle (3) traveling in the communication corridor (2) is stabilized horizontally by leveling wheels (28, 29).

66. The transport infrastructure according to claim 7, wherein the individual vehicle (3) is of modular design and consists of, at least, a universal carrier module (23), as well as a transport module (24) arranged in the form of a passenger cabin or a cargo container whilst the transport module (24) of the individual vehicle (3) is attached to the universal carrier module (23), which is prepared for travel on the public roads (5) and in the communication corridors (2) and is equipped with at least one propulsion module (25).
